(19) United States
(12) Patent Application Publication
(10) Pub. No.: US 2011/0090154 A1
(43) Pub. Date: Apr. 21, 2011

(54) TOUCH PANEL

(75) Inventor: Chun-Ku Kuo, Taoyuan County (TW)

(73) Assignee: AU OPTRONICS CORPORATION, Hsinchu (TW)

(21) Appl. No.: 12/701,614

(22) Filed: Feb. 8, 2010

(30) Foreign Application Priority Data
Oct. 15, 2009 (TW) 98134927

(51) Int. Cl. G06F 3/041

(52) U.S. Cl. 345/173; 178/18.03

(57) ABSTRACT

A touch panel including a substrate, a plurality of sensing series and a floating conductive pattern is provided. The sensing series are disposed on the substrate, wherein the sensing series are electrically insulated from each other. The floating conductive pattern is disposed on the substrate and between the sensing series, wherein the floating conductive pattern includes one or more slits, and the one or more slits adjacent to one of the sensing pads is/are arranged in a path similar to a contour of the corresponding the sensing pads.

### CROSS-REFERENCE TO RELATED APPLICATION

This application claims the priority benefit of Taiwan application serial no. 98134927, filed Oct. 15, 2009. The entirety of the above-mentioned patent application is hereby incorporated by reference herein and made a part of specification.

### BACKGROUND OF THE INVENTION

1. Field of the Invention

The present invention relates to a touch panel, more particularly, to a capacitive touch panel.

2. Description of the Related Art

In recent years, along with the rapid developments of the various applications of information technology, wireless mobile phones and information household appliances, to achieve the goals of more convenient usage, more compact design and more humanized features, many information products have changed their input devices from traditional keyboard or mouse to touch sensing display panel. In terms of the sensing methodology, in general, touch sensing display panels can be roughly categorized into resistive type, capacitive type, optical type, acoustic type and electromagnetic type. Taking the capacitive touch sensing display panel as an example, according to the driving and the sensing manner, the capacitive touch sensing display panel can be further divided into self capacitive type touch sensing display panel and mutual capacitive type touch sensing display panel.

A conventional capacitive type touch sensing display panel includes a plurality of first electrode series extending along the X-axis direction and a plurality of second electrode series extending along the Y-axis direction. When the capacitive touch sensing display panel is touched by a finger, the capacitances between the electrodes of the first and second electrode series would be changed. By delivering the changed signal to a controller, the coordinates of an instantly touching point can be derived. In the conventional capacitive touch panel, even though the electrodes are formed by using transparent conductive material with high transmittance, the transmittance between the region having the transparent conductive material and the region without having transparent conductive material are still different. Therefore, the gap between the electrodes (i.e. the region without distributing transparent conductive material) may be recognized by human eyes, and thus causing an unfavorable visual effect when user uses the touch panel. Accordingly, a floating conductive pattern with the same material as the electrodes is proposed to be disposed at the gap between the electrodes in conventional, so as to reduce the ratio of area occupied by the gap in the touch panel, and thus making that the touch panel has a more uniform transmittance.

However, since the floating conductive pattern is tightly closed to the electrodes and located between the adjacent electrodes, so that the sum value of the parasitic capacitance between the adjacent electrodes would be increased, so as to increase the parasitic capacitance on the transmission path of the serial signal. As a result, not only the sensitivity of the electrodes of the touch panel would be reduced, but also the sensing function of the electrodes would not be normally operated.

### SUMMARY OF THE INVENTION

Accordingly, the present invention is directed to a touch panel with better visual effect, good uniformity in transmittance, and enhanced sensitivity.

The present invention provides a touch panel including a substrate, a plurality of sensing series and a floating conductive pattern. The sensing series are disposed on the substrate, wherein the sensing series are electrically insulated from each other, and each of the sensing series includes a plurality of sensing pads electrically connected with each other. The floating conductive pattern is disposed on the substrate and between the sensing series, wherein the floating conductive pattern includes one or more slits, and the one or more slits adjacent to one of the sensing pads is/are arranged in a path similar to a contour of the corresponding sensing pads.

According to an embodiment of the present invention, each of the sensing pads is a polygon sensing pad, the path is a polygon path, and a coverage of the polygon path is greater than an area of the polygon sensing pad.

According to an embodiment of the present invention, each of the sensing pads is a rectangle sensing pad, the path is a rectangle path, and a coverage of the rectangle path is greater than an area of the rectangle sensing pad.

According to an embodiment of the present invention, each of the sensing pads is a rhombus sensing pad, the path is a rhombus path, and a coverage of the rhombus path is greater than an area of the rhombus sensing pad.

According to an embodiment of the present invention, the slits are arranged in a plurality of ring-like slit sets, and each of the sensing pads is surrounded by one of the ring-like slit sets.

According to an embodiment of the present invention, each of the ring-like slit sets includes a plurality of strip-shaped slits.

According to an embodiment of the present invention, the slits are arranged in a plurality of first ring-like slit sets and a plurality of second ring-like slit sets, each of the sensing pads is surrounded by one of the first ring-like slit sets and one of the second ring-like slit sets, and each of the first ring-like slit sets is located between one of the second ring-like slit sets and one of the sensing pads correspondingly.

According to an embodiment of the present invention, each of the first ring-like slit sets includes a plurality of strip-shaped slits, and each of the second ring-like slit sets includes a plurality of strip-shaped slits.

According to an embodiment of the present invention, an extending direction of each of the slits is substantially parallel to a portion of the path.

According to an embodiment of the present invention, an extending direction of each of the slits is not perpendicular to a portion of the path.

The present invention also provides a touch panel including a substrate, a plurality of inner ring electrode series, a plurality of outer ring electrode series and a floating conductive pattern. The inner ring electrode series are disposed on the substrate and extend along a first direction, wherein each of the inner ring electrode series includes a plurality of inner ring electrodes electrically connected with each other. The outer ring electrode series are disposed on the substrate and extend along a second direction, wherein each of the outer ring electrode series includes a plurality of outer ring electrodes electrically connected with each other, each of the inner ring electrodes is respectively surrounded by one of the outer ring electrodes, the first direction is different from the second direction, the inner ring electrode series are electrically insulated from each other, the outer ring electrode series are electrically insulated from each other, and the inner and outer ring electrode series are electrically insulated from each other. The floating conductive pattern is disposed on the substrate and between the inner and outer ring electrode series, wherein the floating conductive pattern includes one or more slits, and the one or more slits adjacent to one of the inner and outer ring electrode series is/are arranged in a path similar to a contour of the corresponding outer ring electrode series.

According to an embodiment of the present invention, a portion of the floating conductive pattern extends between the plurality of inner ring electrodes and the plurality of and outer ring electrodes.

According to an embodiment of the present invention, each of the outer ring electrode series is a strip-shaped conductor having a plurality of notches, and a portion of the inner ring electrodes are located in the notches.

According to an embodiment of the present invention, the first direction is substantially perpendicular to the second direction.

According to an embodiment of the present invention, the touch panel further includes a patterned dielectric layer located at the intersections of the plurality of inner ring electrode series and the plurality of outer ring electrode series.

According to an embodiment of the present invention, an extending direction of each of the slits is not perpendicular to a portion of the path.

The present invention further provides a touch panel including a substrate, a plurality of first sensing series, a plurality of second sensing series and a floating conductive pattern. The first sensing series are disposed on the substrate and extend along a first direction, wherein each of the first sensing series includes a plurality of first sensing pads electrically connected with each other. The second sensing series are disposed on the substrate and extend along a second direction, wherein each of the second sensing series includes a plurality of second sensing pads electrically connected with each other, the first direction is different from the second direction, the first sensing series are electrically insulated from each other, the second sensing series are electrically insulated from each other, and the first and second sensing series are electrically insulated from each other. The floating conductive pattern is disposed on the substrate and between the first and second sensing series, wherein the floating conductive pattern includes one or more slits, and the one or more slits adjacent to one of the first and second sensing pads is/are arranged in a path similar to a contour of the corresponding first sensing pads and the corresponding second sensing pads.

According to an embodiment of the present invention, the first direction is substantially perpendicular to the second direction.

According to an embodiment of the present invention, the touch panel further includes a patterned dielectric layer located at the intersections of the plurality of first sensing series and the plurality of second sensing series.

According to an embodiment of the present invention, an extending direction of each of the slits is not perpendicular to a portion of the path.

Based on the described above, the floating conductive patter having a plurality of slits is disposed between the sensing pads (or the electrodes) of the touch panel in the present invention, wherein the slits may reduce the parasitic capacitance between the sensing pads (or the electrodes), so as to improve the sensitivity of the sensing pads (or the electrodes). Therefore, the touch panel of the present invention has better visual effect, transmittance uniformity, and sensitivity.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is top-view of a touch panel according to a first embodiment of the present invention, FIG. 1B is a cross-sectional view corresponding to FIG. 1A along line I-I′, FIG. 1C is a cross-sectional view corresponding to FIG. 1A along line II-II′, and FIG. 1D is an enlarged view of the sensing pad and the floating conductive pattern in FIG. 1A.

FIG. 2 is top-view of a touch panel according to another embodiment of the present invention.

FIG. 3A is top-view of a touch panel according to a second embodiment of the present invention, FIG. 3B is a cross-sectional view corresponding to FIG. 3A along line I-I′, and FIG. 3C is a cross-sectional view corresponding to FIG. 3A along line II-II′.

FIG. 4A is top-view of a touch panel according to a third embodiment of the present invention, FIG. 4B is a cross-sectional view corresponding to FIG. 4A along line I-I′.

FIG. 5 is top-view of a touch panel according to a third embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### First Embodiment

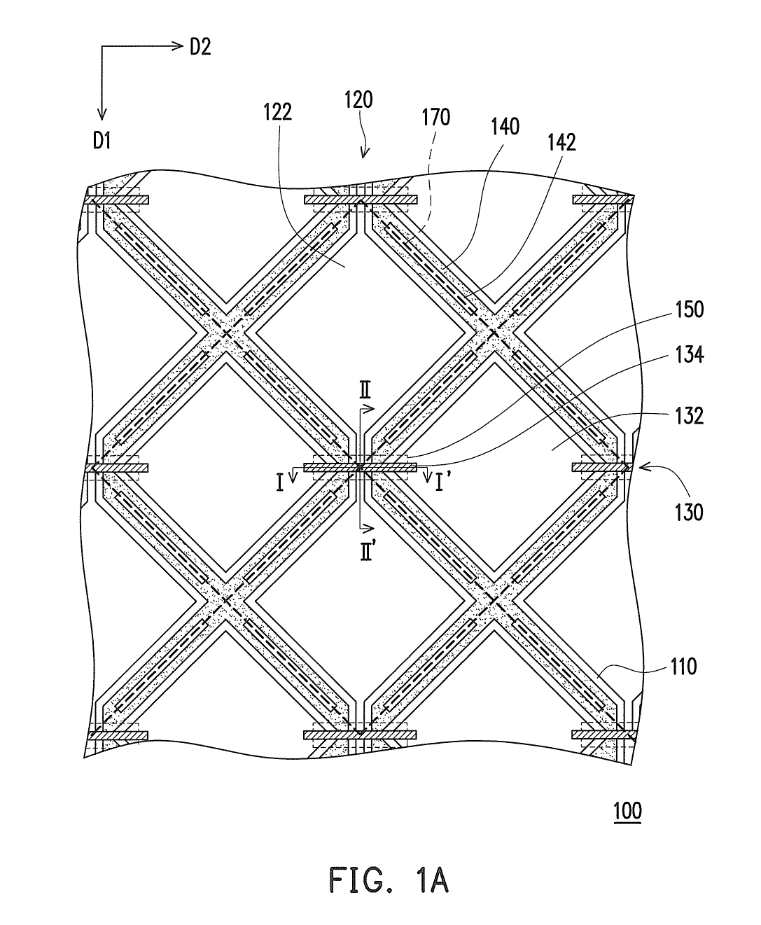

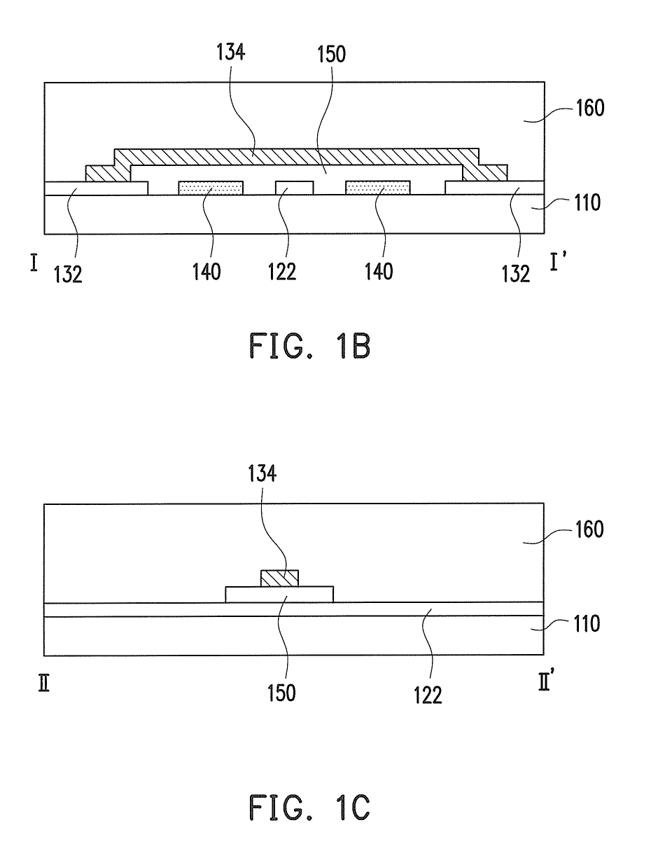

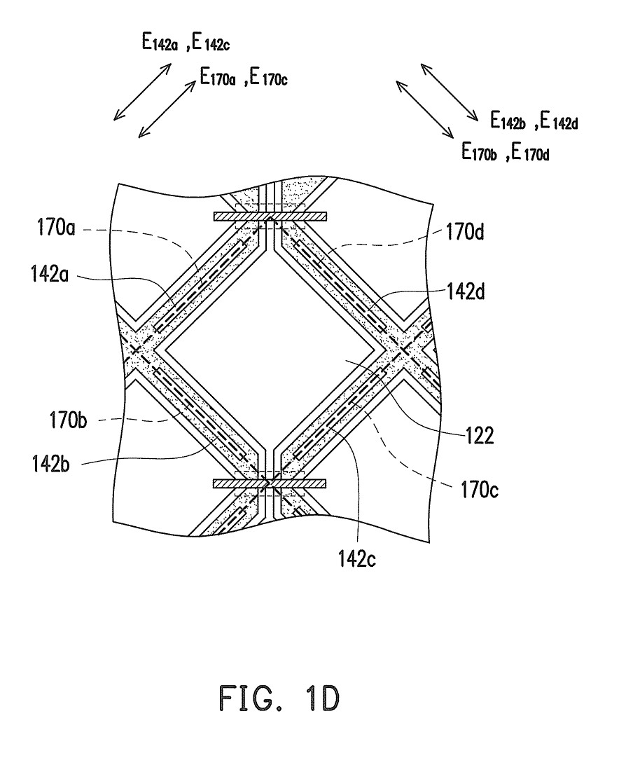

FIG. 1A is top-view of a touch panel according to a first embodiment of the present invention, FIG. 1B is a cross-sectional view corresponding to FIG. 1A along line I-I′, FIG. 1C is a cross-sectional view corresponding to FIG. 1A along line and FIG. 1D is an enlarged view of the sensing pad and the floating conductive pattern in FIG. 1A.

First, referring to FIG. 1A, the touch panel 100 includes a substrate 110, a plurality of first sensing series 120, a plurality of second sensing series 130 and a floating conductive pattern 140. The plurality of first sensing series 120 are disposed on the substrate 110 and extend along a first direction D1, wherein each of the plurality of first sensing series 120 includes a plurality of first sensing pads 122 electrically connected with each other. The plurality of second sensing series 130 are disposed on the substrate 110 and extend along a second direction D2, wherein the first direction D1 is different from the second direction D2. Each of the plurality of second sensing series 130 includes a plurality of second sensing pads 132 and a plurality of bridging lines 134 disposed between the second sensing pads 132, wherein the plurality of second sensing pads 132 are electrically connected with each other by the bridging lines 134. In the present embodiment, the plurality of first sensing series 120 are electrically insulated from each other, and the plurality of second sensing series 130 are electrically insulated from each other. The first sensing pads 122 and the second sensing pads 132 may be the rectangle pads. The material of the first sensing pads 122 and the second sensing pads 132 may be the transparent conductive material. The material of the bridging lines 134 may be the transparent conductive material or the non-transparent conductive material. In addition, in the present embodiment, the first direction D1 may be substantially perpendicular to the second direction D2. However, in an alternative embodiment of the present invention, the included angles between the first direction D1 and the second direction D2 may have other values.

Referring to FIGS. 1A, 1B and 1C, the touch panel 100 of the present embodiment may further include a patterned dielectric layer 150 and a protection layer 160. The patterned dielectric layer 150 is located between and/or at the intersections of the first sensing series 120 and the second sensing series 130 so as to make sure that the first sensing series 120 and the second sensing series 130 are electrically insulated from each other. In addition, the protection layer 160 covers the first sensing series 120 and the second sensing series 130.

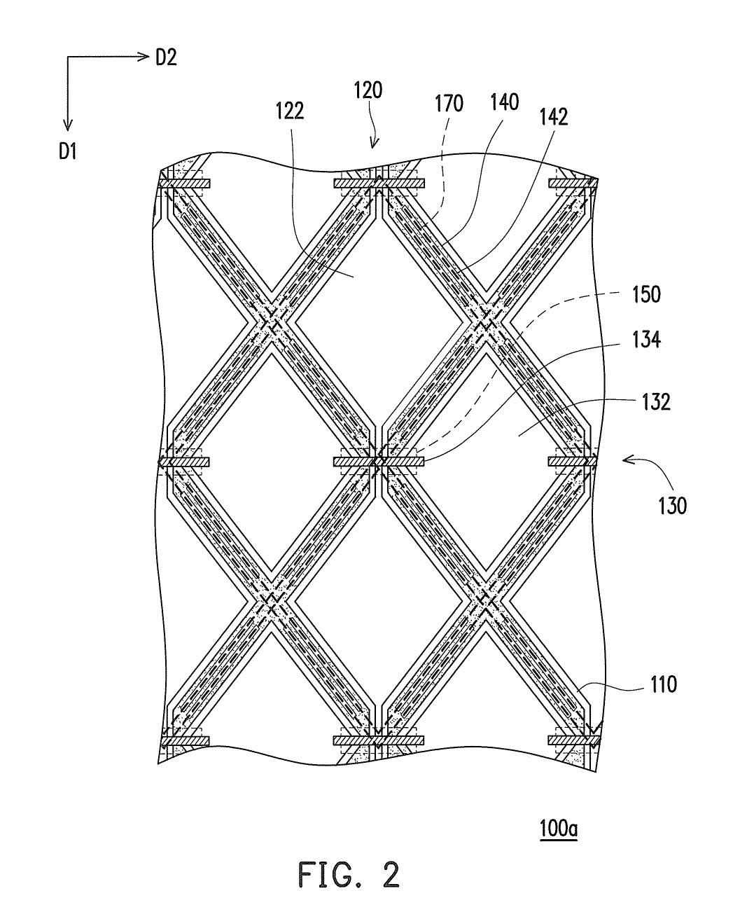

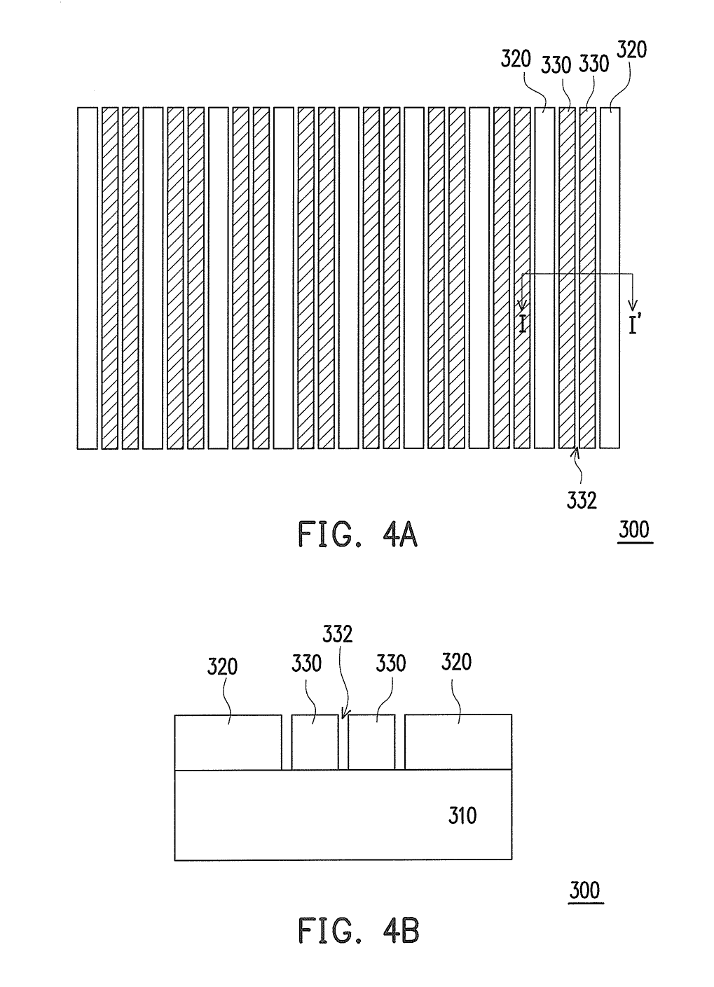

Referring to FIG. 1A, the floating conductive pattern 140 is disposed on the substrate 110 and disposed between the first sensing series 120 and the second sensing series 130. The floating conductive pattern 140 includes one or more slit(s) 142, and one or more slit(s) 142 adjacent to one of the sensing pads 122 (or 132) is/are arranged in a path 170 similar to the contour of the corresponding sensing pads 122 (or 132). In addition, the extending direction of each of the slits 142 may not be perpendicular to a portion of the path 170, or may not be perpendicular to the sides of the adjacent sensing pads 122 (or 132). In the present embodiment, the contour of the sensing pads 122, 132 may be the rectangle, such that the path 170 is the rectangle path, and the coverage of the rectangle path 170 is greater than the area of the rectangle sensing pads 122, 132, or the rectangle path 170 surrounds the rectangle sensing pad(s) 122 (or 132). To be specific, referring to FIG. 1D, take the first sensing pads 122 for example, the slits adjacent to the sensing pad 122 include the slits 142a, 142b, 142c and 142d, and the slits 142a, 142b, 142c and 142d are arranged on the path 170 and respectively located on the sub-paths 170a, 170b, 170c and 170d. The extending directions E₁₄₂ₐ, E_{142b}, E_{142c} and E_{142d} of the slits 142a, 142b, 142c and 142d are not perpendicular to the extending directions E₁₇₀ₐ, E_{170b}, E_{170c} and E_{170d} of the sub-paths 170a, 170b, 170c and 170d, respectively. To be specific, the slit 142a is located on the sub-path 170a, and the extending direction E₁₄₂ₐ of the slit 142a is not perpendicular to the extending direction E₁₇₀ₐ of the sub-path 170a, wherein the extending direction E₁₄₂ₐ of the slit 142a may be substantially parallel to the extending direction E₁₇₀ₐ of the sub-path 170a. Similarly, the rest of slits 142b, 142c and 142d are respectively located on the sub-paths 170b, 170c and 170d. The extending directions E_{142b}, E_{142c} and E_{142d} of the rest of slits 142b, 142c and 142d may also respectively be substantially parallel to the extending directions E_{170b}, E_{170c} and E_{170d} of the sub-paths 170b, 170c and 170d. Obviously, in the other embodiments of the present invention, the extending directions of the slits 142a, 142b, 142c and 142d may not also be parallel to the extending directions of the sub-paths 170a, 170b, 170c and 170d, respectively. That is, the included angles between the extending direction of the slit 142a/142b/142c/142/d and the extending direction of the sub-path 170a/170b/170c/170d may have other values except 0-degree and 90-degree. Furthermore, the sensing pad 122 is an example in FIG. 1D, the configuration of the one or more slit(s) adjacent to the same sensing pad 132 is/are similar to the configuration as shown in FIG. 1D. Referring to FIG. 1A, in the present embodiment, the slits 142 may include a plurality of ring-like slit sets, and each of the sensing pads 122, 132 is surrounded by one of the ring-like slit sets. Take FIG. 4 for example, the slits 142a, 142b, 142c and 142d constitute a ring-like slit set, and the sensing pad 122 is surrounded by this ring-like slit set. In an alternative embodiment, the slits 142 may include a plurality of first ring-like slit sets and a plurality of second ring-like slit sets, each of the sensing pads is surrounded by one of the first ring-like slit sets and one of the second ring-like slit sets, and the first ring-like slit sets is located between the second ring-like slit sets and the sensing pads correspondingly. For example, in the touch panel 110a as shown in FIG. 2, the floating conductive pattern 140 includes a plurality of slits 142, and the slits 142 includes a plurality of first ring-like slit sets and a plurality of second ring-like slit sets. In view of a single sensing pad 122 (or 132), the slits 142 closer to the sensing pad 122 (or 132) constitute a first ring-like slit set, and the slits 142 farther to the sensing pad 122 (or 132) constitute a second ring-like slit set, wherein the first ring-like slit set is located between the second ring-like slit set and the sensing pad 122 (or 132). In other words, the slits 142 may have a various shapes and arrangements. In addition, in the touch panel 100a, the sensing pads 122, 132 may be the rhombus sensing pads, such that the path 170 is the rhombus path, and the coverage of the rhombus path 170 is greater than the area of the rhombus sensing pads 122, 132, or the rhombus path 170 surrounds the rhombus sensing pad(s) 122 (or 132). In an alternative embodiments (not shown), the sensing pads 122, 132 may be the polygon sensing pads such as the pentagon-shaped, the hexagon-shaped, etc. expect the above rectangle and rhombus sensing pads, such that the path 170 is corresponding to the polygon path, and the coverage of the polygon path 170 is greater than the area of the polygon sensing pads 122, 132, or the polygon path 170 surrounds the polygon sensing pad(s) 122 (or 132).

In general, the touch panel has a more uniform transmittance because of the disposing of the floating conductive pattern between the sensing pads. However, the overall parasitic capacitance between the adjacent sensing pads would increase. As a result, not only the sensitivity of the sensing pads would be reduced, but also the sensing function of the sensing pads would not be normally operated possibly. However, in the above embodiments, the floating conductive patterns 140 of the touch panels 100 and 100a respectively have a plurality of slits 142, and the plurality of slits 142 can effectively reduce the parasitic capacitance between the sensing pads, so as to improve the sensitivity of touch panel 100. Therefore, in the touch panel of the above embodiments, the configuration of the floating conductive pattern can effectively improve the transmittance uniformity and visual effect of the touch panel, and the slits of the floating conductive pattern further may make the sensing pads with good sensitivity. From the above, the touch panel of the present embodiment has better visual effect, transmittance uniformity, and sensitivity.

### Second Embodiment

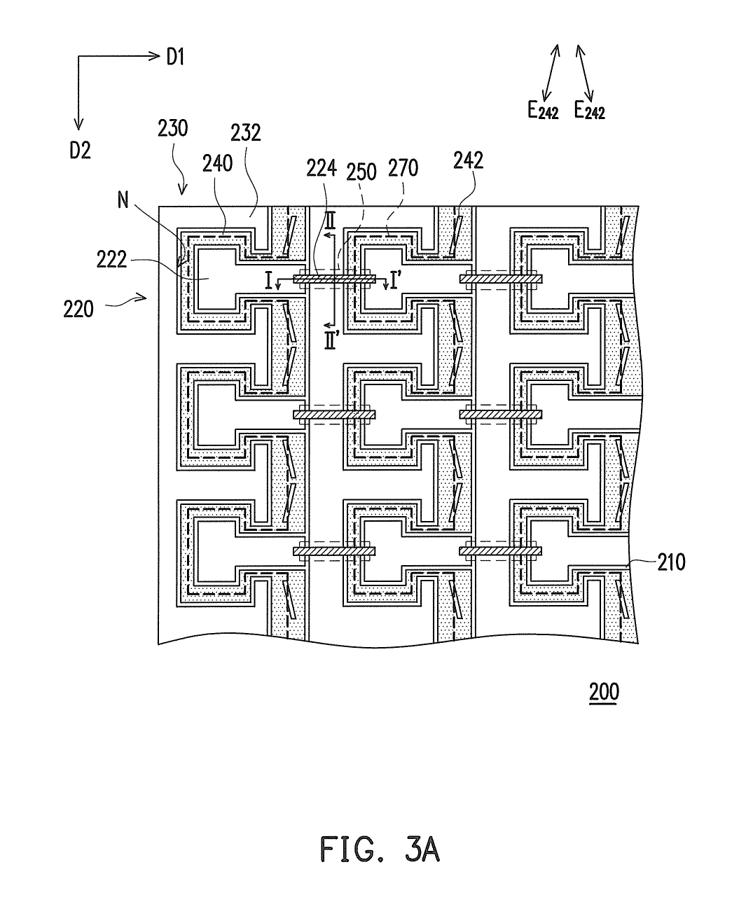

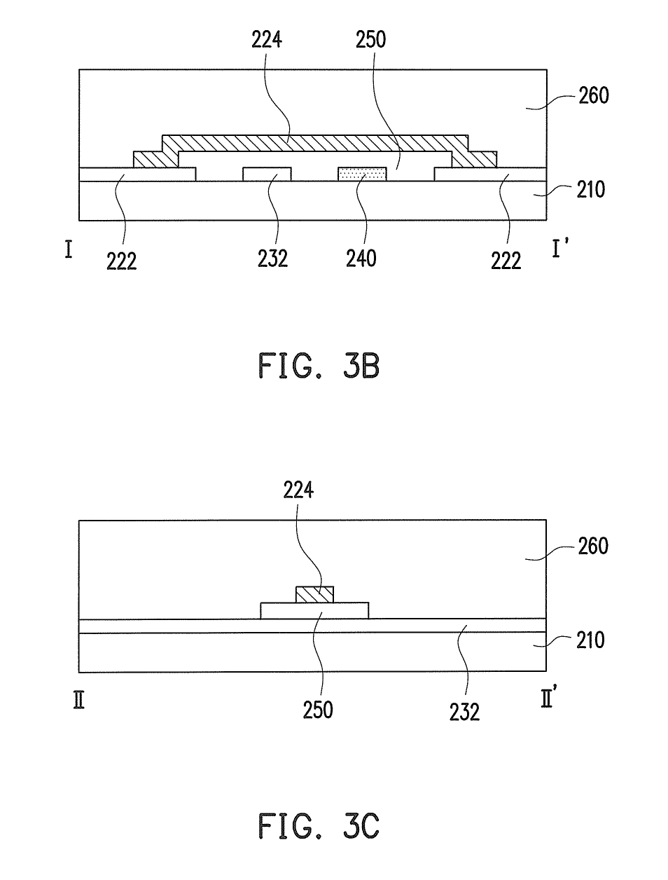

FIG. 3A is top-view of a touch panel according to a second embodiment of the present invention, FIG. 3B is a cross-sectional view corresponding to FIG. 3A along line I-I′, and FIG. 3C is a cross-sectional view corresponding to FIG. 3A along line II-II′.

Referring to FIG. 3A, in the present embodiment, the touch panel 200 includes a substrate 210, a plurality of inner electrode series 220, a plurality of outer electrode series 230 and a floating conductive pattern 240. The plurality of inner electrode series 220 are disposed on the substrate 210 and extend along a first direction D1, wherein each of the plurality of inner electrode series 220 includes a plurality of inner electrodes 222 electrically connected with each other. In the present embodiment, the plurality of inner electrode series 220 are electrically insulated from each other, and the material of the plurality of inner electrodes 222 may be the transparent conductive material. The plurality of outer electrode series 230 are disposed on the substrate 210 and extend along a second direction D2, wherein each of the plurality of outer electrode series 230 includes a plurality of outer electrodes 232 electrically connected with each other, each of the plurality of inner electrodes 222 is respectively surrounded by one of the outer electrodes 232, and the first direction D1 is different from the second direction D2. In the present embodiment, the first direction D1 may be substantially perpendicular to the second direction D2. The material of the plurality of outer electrode series 230 may be the transparent conductive material, and the plurality of outer electrode series 230 are electrically insulated from each other. To be specific, the plurality of outer electrode series 230 may be a strip-shaped conductor, and this strip-shaped conductor includes a plurality of outer electrodes 232 and a plurality of notches N, wherein at least a portion of inner electrodes 222 are located in the notches N. In the present embodiment, the shape of the notches N may be a rectangle. The shape of the inner electrodes 222 located in the notches N may be corresponding to the shape of the notches N, i.e. the rectangle. However, in an alternative embodiment, the shape of the notches N may be the circle-shaped, the polygon or other shapes, while the shape of the inner electrodes 222 located in the notches N may also be the circle-shaped, the polygon or other shapes. The shape of the inner electrodes 222 located in the notches N may not the same with the shape of the notches N. Therefore, there are various combinations between the shape of the notches N and the shape of the inner electrodes 222 located in the notches N.

Referring to FIGS. 3A, 3B and 3C, in the present embodiment, the plurality of inner electrode series 220 further include a plurality of bridging lines 224 disposed between the inner electrodes 222, and the inner electrodes 222 are electrically connected with each other by the bridging lines 224. In the present embodiment, the material of the bridging lines 224 may be transparent conductive material or non-transparent conductive material, for example, metal. Furthermore, in the present embodiment as shown in FIGS. 3B and 3C, the touch panel 200 further includes a patterned dielectric layer 250 and a protection layer 260. The patterned dielectric layer 250 is located at the intersections of the inner ring series 220 and the outer electrode series 230 (that is, between the bridging lines 224 and the outer ring electrode series 230) so as to make sure that the inner electrode series 220 and the outer electrode series 230 are electrically insulated from each other. In addition, the protection layer 260 covers the inner electrode series 220 and the outer electrode series 230.

Referring to FIG. 3A, the floating conductive pattern 240 is disposed on the substrate 210 and between the inner and outer electrode series 220 and 230, and a portion of the floating conductive pattern 240 may extend between the inner and outer electrode 222 and 232. Accordingly, the floating conductive pattern 240 substantially surrounds the inner electrode 222 and outer ring electrode series 230. The floating conductive pattern 240 includes a plurality of slits 242, and the one or more slit(s) 242 adjacent to one of the inner and outer ring electrode series 220 (or 230) is/are arranged in a path 270 (dotted line in FIG. 3A) similar to a contour of the inner electrode series 220 and outer electrode series 230. And, the extending direction of each of the slits 242 may not be perpendicular to a portion of the path 270. In the present embodiment, the included angles between the extending direction E₂₄₂ of the slit 242 and the path 270 may have 30-degree. In another embodiment, the extending direction E₂₄₂ of the slit 242 may be substantially parallel to the path 270, or the included angles between the extending direction E₂₄₂ of the slit 242 and the path 270 is not limited in the present invention. Furthermore, the included angles between the extending directions E₂₄₂ of all of the slit 242 and any straight portion of the path 270 may have the same values/degree, for example, 30-degree. However, in the other embodiments, the included angles between the extending direction E₂₄₂ of each of the slit 242 and the path 270 may have the respective values/degree. Moreover, the configuration of the slits 242 shown in FIG. 3A is only one of various configurations for slits. In other words, the slits 242 may be disposed on any positions of the floating conductive pattern 240 according to the requirement of products.

In the present embodiment, the transmittance uniformity and visual effect of the touch panel 200 can be effectively improved by disposing the floating conductive pattern 240, and the slits 242 of the floating conductive pattern 240 may maintain good sensitivity of the inner electrodes 222 and the outer electrodes 232. Therefore, the touch panel 200 of the present embodiment has better visual effect, transmittance uniformity, and sensitivity.

In summary, the parasitic capacitance between the sensing pads (or the electrodes) may be reduced by disposing the slits in the floating conductive pattern, so as to improve the sensitivity of the sensing pads (or the electrodes). Therefore, not only the touch panel has better visual effect and transmittance uniformity, but also has good sensitivity in operating.

### Third Embodiment

FIG. 4A is top-view of a touch panel according to a third embodiment of the present invention, FIG. 4B is a cross-sectional view corresponding to FIG. 4A along line I-I′. Referring to FIG. 4A and FIG. 4B, the touch panel 300 of the present embodiment is similar with the touch panel 100 of the first embodiment except that the pattern of the sensing series 320 and the floating conductive pattern 330. In the present embodiment, the plurality of sensing series 320 are disposed on a substrate 310, wherein each of the plurality of sensing series 320 is of a stripe shape. The sensing series 320 are electrically insulated from each other. The floating conductive pattern 330 is disposed on the substrate 310 and located between two adjacent sensing series 320. The material of the sensing series 320 and the floating conductive pattern 330 may be made from transparent conductive material, e.g. ITO, IZO and so on. Specifically, the floating conductive pattern 330 includes one or more slit(s) 332, wherein the slit(s) 332 may be arranged in a path similar to a contour of the sensing series 320. In other words, the extending direction of the slit(s) 332 is substantially parallel to the sensing series 320.

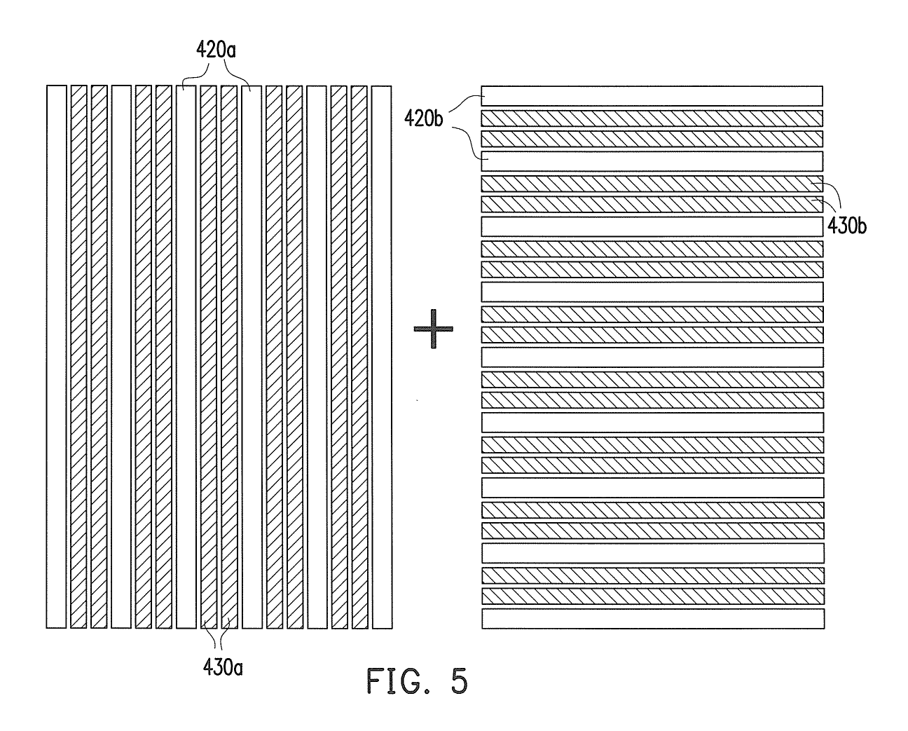

FIG. 5 is top-view of a touch panel according to a third embodiment of the present invention. Referring to FIG. 5, the touch panel 400 of the present embodiment is similar with the touch panel 300 of the third embodiment except that sensing series 420a and 420b arranged in different layers are formed. In addition, two floating conductive pattern 430a and 430b are formed also. Specifically, the floating conductive pattern 430a is between the sensing series 420a while the floating conductive pattern 430b is between the sensing series 420b.

It will be apparent to those skills in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A touch panel, comprising:
a substrate;
a plurality of sensing series disposed on the substrate, wherein the plurality of sensing series are electrically insulated from each other, and each of the plurality of sensing series comprises one sensing pad or a plurality of sensing pads electrically connected with each other; and
a floating conductive pattern disposed on the substrate and between the plurality of sensing series, the floating conductive pattern comprising one or more slits, and the one or more slits adjacent to one of the plurality of sensing pads being arranged in a path similar to a contour of the corresponding sensing pads.

2. The touch panel according to claim 1, wherein each of the sensing pads is a polygon sensing pad, the path is a polygon path, and a coverage of the polygon path is greater than an area of the polygon sensing pad.

3. The touch panel according to claim 1, wherein each of the sensing pads is a rectangle sensing pad, the path is a rectangle path, and a coverage of the rectangle path is greater than an area of the rectangle sensing pad.

4. The touch panel according to claim 1, wherein each of the sensing pads is a rhombus sensing pad, the path is a rhombus path, and a coverage of the rhombus path is greater than an area of the rhombus sensing pad.

5. The touch panel according to claim 1, wherein the plurality of slits include a plurality of ring-like slit sets, and each of the plurality of sensing pads is surrounded by one of the plurality of ring-like slit sets.

6. The touch panel according to claim 5, wherein each of the plurality of ring-like slit sets comprises a plurality of strip-shaped slits.

7. The touch panel according to claim 1, wherein the plurality of slits are include a plurality of first ring-like slit sets and a plurality of second ring-like slit sets, each of the sensing pads is surrounded by one of the plurality of first ring-like slit sets and one of the plurality of second ring-like slit sets, and each of the plurality of first ring-like slit sets is located between one of the plurality of second ring-like slit sets and one of the sensing pads correspondingly.

8. The touch panel according to claim 7, wherein each of the plurality of first ring-like slit sets comprises a plurality of strip-shaped slits, and each of the plurality of second slit ring sets comprises a plurality of strip-shaped slits.

9. The touch panel according to claim 1, wherein an extending direction of each of the plurality of slits is substantially parallel to a portion of the path.

10. The touch panel according to claim 1, wherein an extending direction of each of the plurality of slits is not perpendicular to a portion of the path.

11. A touch panel, comprising:
a substrate;
a plurality of inner electrode series disposed on the substrate and extending along a first direction, wherein each of the plurality of inner electrode series comprises a plurality of inner electrodes electrically connected with each other;
a plurality of outer electrode series disposed on the substrate and extending along a second direction, wherein each of the plurality of outer electrode series comprises a plurality of outer electrodes electrically connected with each other, each of the plurality of inner electrodes is respectively surrounded by one of the plurality of outer electrodes, the first direction is different from the second direction, the plurality of inner electrode series are electrically insulated from each other, the plurality of outer electrode series are electrically insulated from each other, and the plurality of inner and outer electrode series are electrically insulated from each other; and
a floating conductive pattern disposed on the substrate and between the plurality of inner and outer electrode series, the floating conductive pattern comprising one or more slits, and one or more slits adjacent to one of the plurality of inner and outer electrode series being arranged in a path similar to a contour of the corresponding electrode series.

12. The touch panel according to claim 11, wherein a portion of the floating conductive pattern extends between the plurality of inner electrodes and the plurality of outer electrodes.

13. The touch panel according to claim 11, wherein each of the plurality of outer electrode series is a strip-shaped conductor having a plurality of notches, and a portion of the plurality of inner electrodes are located in the plurality of notches.

14. The touch panel according to claim 11, wherein the first direction is substantially perpendicular to the second direction.

15. The touch panel according to claim 11, further comprising:
a patterned dielectric layer located at the intersections of the plurality of inner electrode series and the plurality of outer electrode series.

16. The touch panel according to claim 11, wherein an extending direction of each of the plurality of slits is not perpendicular to a portion of the path.

17. A touch panel, comprising:
a substrate;
a plurality of first sensing series disposed on the substrate and extending along a first direction;
a plurality of second sensing series disposed on the substrate and extending along a second direction, the first direction is different from the second direction, the plurality of first sensing series are electrically insulated from each other, the plurality of second sensing series are electrically insulated from each other, and the plurality of first and second sensing series are electrically insulated from each other; and
a floating conductive pattern disposed on the substrate and between the plurality of first and second sensing series, the floating conductive pattern comprising one or more slits, and the one or more slits adjacent to one of the plurality of first and second sensing pads being arranged in a path similar to a contour of the corresponding first sensing pads and the corresponding second sensing pads.

18. The touch panel according to claim 17, wherein the first direction is substantially perpendicular to the second direction.

19. The touch panel according to claim 17, further comprising:
a patterned dielectric layer located at the intersections of the plurality of first sensing series and the plurality of second sensing series.

20. The touch panel according to claim 17, wherein an extending direction of each of the plurality of slits is not perpendicular to a portion of the path.

21. The touch panel according to claim 17, wherein each of the plurality of first sensing series comprises one first sensing pad or a plurality of first sensing pads electrically connected with each other.

22. The touch panel according to claim 17, wherein each of the plurality of second sensing series comprises one first sensing pad or a plurality of second sensing pads electrically connected with each other.
